(19) United States
(12) Patent Application Publication
(10) Pub. No.: US 2011/0182172 A1
(43) Pub. Date: Jul. 28, 2011

(54) Auto Mesh Discovery Mechanism

(76) Inventor: Sudarshan Kulkarni, Bangalore Karnataka (IN)

(21) Appl. No.: 12/694,087

(22) Filed: Jan. 26, 2010

(51) Int. Cl. H04J 3/14; H04W 72/04

(52) U.S. Cl. 370/221; 370/329

(57) ABSTRACT

Activating an Access Point (AP) on a Mesh Network. In a wireless Mesh network, only a subset of nodes in the network have wired connections to a controller. An AP is preprogrammed so that when it is placed in operation, it attempts to contact a controller to receive provisioning information for it to provide services as intended. If this attempt to make a wired or pre programmed wireless mesh network connection fails, the AP initiates the procedure to establish a special mesh wireless connectivity. Other active nodes in the network respond to this special mesh wireless procedure and a wireless link is established between the AP and a node forming a Mesh network. Authentication such as verification of certificates may be performed. The AP receives provisioning information for operating on the network either from the Mesh node, or through the Mesh network from the controller. Once the AP has received and verified the information, it places itself in operation as a new node on the Mesh network or be ready for the intended deployment else where as an AP or join the network and begin providing services using new information acquired.

### BACKGROUND OF THE INVENTION

The present invention relates to wireless digital networks, and in particular, to the problem of activating access points over a wireless Mesh Network by leveraging wireless connectivity for further provisioning.

Wireless digital networks are becoming ubiquitous in enterprises, providing secure and cost-effective access to resources. Those networks usually have one or more controllers, each controller supporting a plurality of access points (AP) deployed through the enterprise. Each AP provides wireless connectivity to client devices. WiFi networks operating in accordance with IEEE 802.11 standards are examples of such networks

In a first type of network, access points (APs) each have a wired connection back to a supporting controller. This wired connection may be direct to the controller, or it may be through a series of layer 2 or layer 3 switches.

Other network installations however present situations where wired connections to access points are difficult if not impossible. In such situations, Mesh networks are used, where APs connect wirelessly to each other and eventually back to an access point known as a root node which has a wired connection to the host controller, or contains controller functionality.

When new access points are added to a network, they must first be provisioned, providing them with the information and updates they need to operate on the network. Provisioning information can include operating channels, power levels, BSSIDs to advertise, other operating information, and possibly code updates.

As is known to the art, when an access point starts up with a wired connection back to its host controller, it uses a combination of approaches to establish a connection. The AP may have previously been provisioned with the address of the host controller. In this case, the AP attempts to establish a connection to that address, verify the host controller, commonly through a cryptographic exchange, and retrieve provisioning and operating information. The AP can then join the network and begin providing services.

In a second approach known to the art, the AP uses a method to discover the address of the host controller. DNS services, DHCP options, or the DHCP server address itself are examples of methods to discover the host controller address. As an example, DNS on the wired network resolves a preset FQDN to an address. If the AP uses DHCP for getting an address, the DHCP server field or vendor defined DHCP option can be used as the host controller address. The AP uses such an obtained address to establish a connection with the host controller, proceeding as previously described.

But when an AP is put into Mesh service, it has no wired connection. The wired approaches described will fail. Even in a provisioned Mesh Network, connectivity with the host controller could fail due to various reasons causing a previously provisioned Mesh Node to fail to establish a connection with host controller. One such scenario could be failing to distribute a configuration change to a provisioned Mesh Node due to an uncontrolled situation over the wireless medium such as high interference, noise, root mesh node failure, and so on.

Even in the presence of a wired connection, connectivity with a host controller may fail. This may occur for example due to failure of components in the wired link, such as wiring, routers, switches, and the like, mis-configuration of network elements, and so on.

What is needed is a way of activating wireless access points on a Mesh network when the methods involving previously described procedures fail.

### BRIEF DESCRIPTION OF THE DRAWINGS

The invention may be best understood by referring to the following description and accompanying drawings that are used to illustrate embodiments of the invention in which:

FIG. 1 shows a wireless network, and

FIG. 2 shows a flowchart of the invention.

### DETAILED DESCRIPTION

Embodiments of the invention relate to methods of activating an access point in a wireless Mesh network. According to the invention, an access point (AP) starts up and attempts to establish a wired connection with a host controller. If these attempts fail, as no wired connection is present or the preconfigured host controller is not reachable, the access point scans a range of wireless channels in accordance with regulatory requirements, builds a list of active APs on the wireless network, selects a suitable AP, and wirelessly connects with the suitable AP. The AP then retrieves provisioning information and establishes itself as a node on the wireless network.

According to the invention, the scanning process includes sending a probe-request and receiving probe-response from multiple active APs, or listening for beacons transmitted by multiple active APs. Scanning a range of channels allows populating the list of active APs. Then the scanning AP checks if the active AP has the capability to carry out the procedures of the invention and selects the best AP to initiate the association procedure. The scanning access point sends out a probe request on the channel where the capable access point is active. Active nodes on the network are programmed to respond to these probe requests. An active AP now acting as a mesh node responds to the probe request with a probe response, and activates the BSS to facilitate the association. The active AP then continues the procedure to associate the scanning AP and to operate in the Mesh network.

According to the invention, the scanning AP verifies if the active APs are capable of carrying out the procedures defined in the invention. Such verification may include for example the presence of a vendor specific 802.11 informational element in beacons and probe responses, or the presence of a particular key string in an ESSID.

The association process may be followed by verification of the authenticity of the AP by the Mesh network, and/or verification of the Mesh network by the AP. This verification may be done through cryptographic exchanges known to the art. This link may be authenticated, for example, using cryptographic certificates pre-stored in the AP and one or more of the Mesh nodes or the controller supporting the Mesh node. Alternately a pre shared key can be used for authentication.

The Access Point which gets activated through the method described can in-turn act as an active AP or parent for other scanning access points.

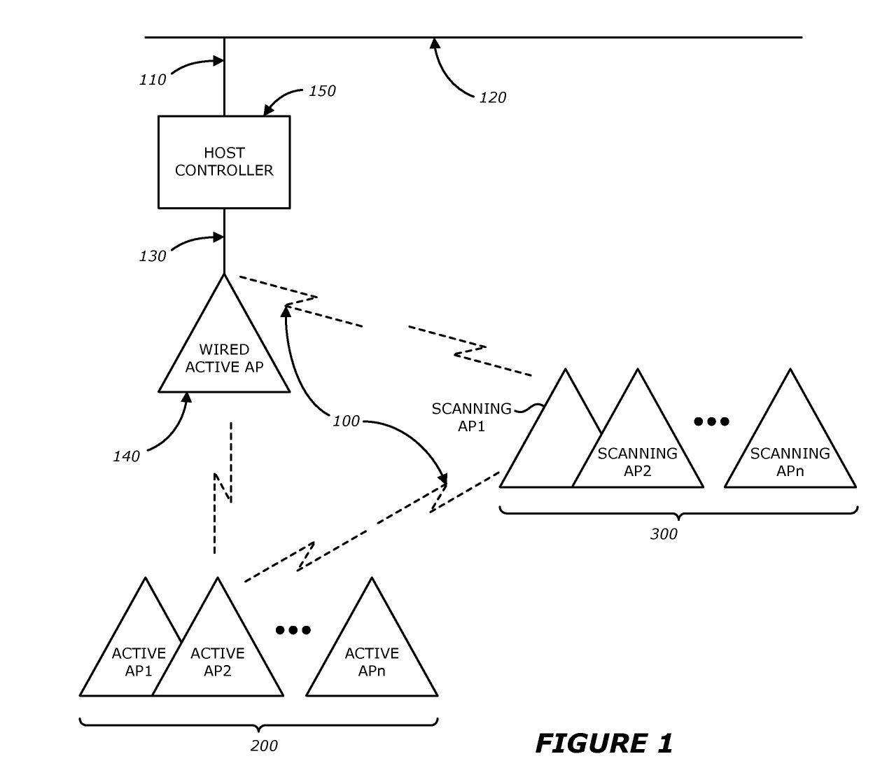

FIG. 1 shows such network in which host controller 150 connects 110 to wired network 120. Host controller 150 also has a wired connection 130 with access point (AP) 140. AP 140 provides services over wireless connection 100. Access points 200 connect wirelessly to access point 140 and also provide wireless connectivity to wireless clients. Access points 300 are unprovisioned and are starting up.

As is known in the art, host controller 150 and access points 140, 200, and 300 are purpose-built digital devices. Each contains a processor, memory hierarchy, and various interfaces. In one embodiment of the invention, a MIPS-class processor such as those from Cavium or RMI is used. Other suitable processors, such as those from Intel or AMD may also be used. The memory hierarchy usually comprises fast read/write memory for holding processor data and instructions while operating, and nonvolatile memory such as EEPROM and/or Flash for storing files and system startup information. Wired interfaces are typically IEEE802.3 Ethernet interfaces, and wireless interfaces may be WiMAX, 3G, 4G, and/or IEEE802.11 wireless interfaces. In one embodiment of the invention, host controller 150 and the access points 200, 300 operate under control of a LINUX operating system, with purpose-built programs providing host controller and access point functionality.

It should be noted that while FIG. 1 shows host controller 150 and access point 140 as separate devices, the functionality of host controller 150 may be combined with that of access point 140 in some embodiments.

As is known to the art, an AP must be provided with certain information before it can begin operating as part of a wireless network. This process is called provisioning. One method of provisioning involves a wired network connection to the AP. When the AP starts up, it attempts to contact a controller to receive the information it needs. The AP may have previously been provisioned with the address of the host controller. In this case, the AP attempts to establish a connection to that address, verify the host controller, commonly through a cryptographic exchange, and retrieve provisioning and operating information. The AP can then join the network and begin providing services.

In a second approach known to the art, the AP uses a method to discover the address of the host controller. DNS services, DHCP options, or the DHCP server address itself are such methods to discover the host controller address. As an example, DNS on the wired network resolves the FQDN to an address. If the AP uses DHCP for getting an address the DHCP server field or vendor defined DHCP options can be used as the host controller address. The AP uses such an obtained address to establish a connection with the host controller, proceeding as previously described.

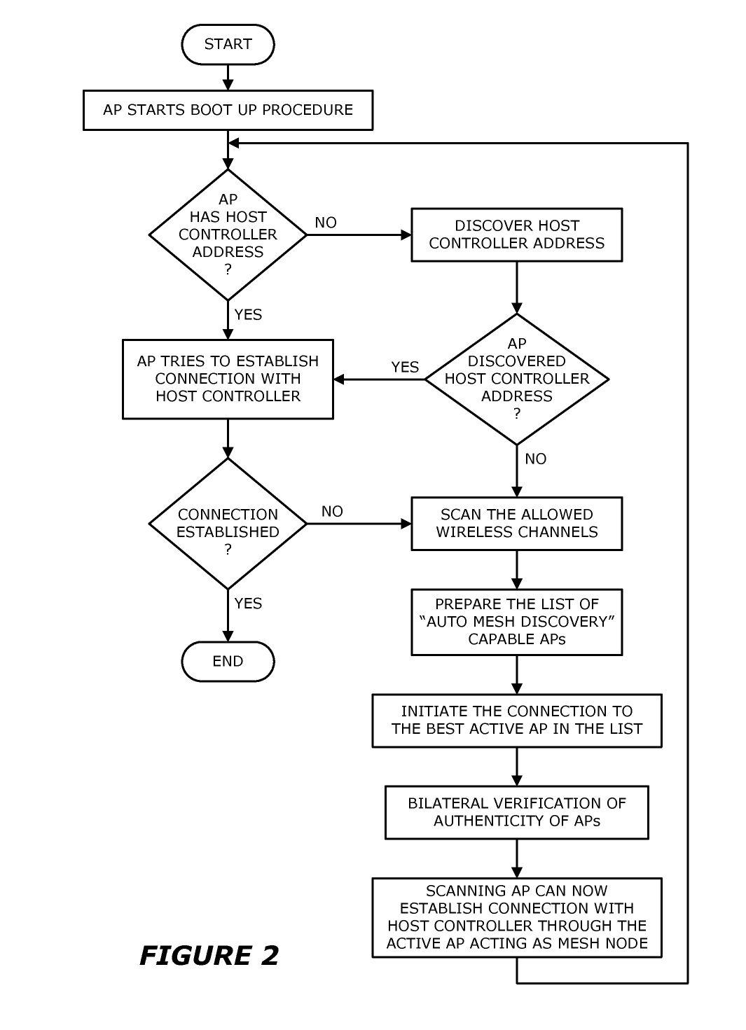

According to the present invention and as shown in FIG. 2, when AP 300 is put into service, it first attempts to make a wired connection to obtain provisioning information. Since AP 300 does not have a wired connection as shown in FIG. 1, these attempts fail. AP 300 then searches for wireless nodes.

Using wireless channels authorized for the present regulatory domain, AP 300 scans a wireless channel, and prepare the list of active APs on the wireless network. Multiple channels over one or more bands may be scanned.

One approach to scanning is for AP 300 to scan one or more channels listening for and recording beacons transmitted by active APs 200 on the wireless network. Another approach to scanning is for AP 300 to transmit probe requests on the channel, and record received probe responses from active APs 200 on the wireless network.

Once AP 300 has formed a list of APs which may be suitable, an AP is selected from this list. Numerous criteria may be used, such as signal strength, or other capabilities advertised by the AP. AP 300 selects an active AP from the list and associates with that AP to begin the provisioning process.

According to the invention, the connection and/or provisioning process may optionally be authenticated, such as through the use of certificates, challenge/response, or other cryptographic processes.

In one embodiment of the invention, provisioning information for AP 300 is provided by an active AP 200 on the Mesh network. This information may include data such as operating channel, BSSIDs, power levels, and other operating characteristics. AP 300 receives this information, validates it, and places itself in operation as a new node on the Mesh network.

In another embodiment of the invention, provisioning information for AP 300 is provided by controller 150 for the Mesh network, with the data flowing through the Mesh, through mesh nodes 140 and 200. Once again, the information provided by controller 150 may include data such as operating channel, BSSIDs, power levels, and other operating characteristics. AP 300 receives this information, validates it, and places itself in operation as a new node on the network.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method of provisioning a node on a wireless network having at least one active wireless node, comprising:
scanning for active nodes on at least one wireless channel,
receiving a response from the at least one active node,
forming a list of active nodes from the responses received,
selecting an active node from the list of active nodes,
associating with the selected active node,
requesting and receiving provisioning information, and
beginning operation as a node on the wireless network using the provisioning information.

2. The method of claim 1 where the steps of scanning for active nodes on the wireless network and receiving a response from at least one active node comprises:
listening for beacons, and
receiving a beacon from at least one active node.

3. The method of claim 1 where the steps of scanning for active nodes on the wireless network and receiving a response from at least one active node comprises:
transmitting a probe request, and
receiving a probe response from at least one active node.

2. The method of claim 1 where the steps of claim 1 are performed after a wired connection attempt by the new node has failed.

3. The method of claim 1 where the provisioning information is provided to the new node by the selected active node.

4. The method of claim 1 where the provisioning information is provided to the new node by a controller through a network connection between the controller and the selected active node.

5. The method of claim 1 where the steps of claim 1 are performed when a host controller supporting nodes on the network becomes unreachable for an already active node.

6. A machine readable medium having a set of instructions stored therein, which when executed on a on a processor embedded in a wireless network node causes a set of operations to be performed comprising:
scanning for active nodes on at least one wireless channel,
receiving a response from the at least one active node,
forming a list of active nodes from the responses received,
selecting an active node from the list of active nodes,
associating with the selected active node,
requesting and receiving provisioning information, and
beginning operation as a node on the wireless network using the provisioning information.

7. The machine readable medium of claim 6 where the set of instructions for scanning for active nodes on at least one wireless channel and receiving a response from the at least one active node further comprise a set of instructions for:
listening for beacons, and
receiving a beacon from at least one active node.

8. The machine readable medium of claim 6 where the set of instructions for scanning for active nodes on at least one wireless channel and receiving a response from the at least one active node further comprise a set of instructions for:
transmitting a probe request, and
receiving a probe response from at least one active node.
